(19) United States
(12) Patent Application Publication
(10) Pub. No.: US 2015/0213018 A1
(43) Pub. Date: Jul. 30, 2015

(54) METHOD FOR RECOMMENDING VIDEOS TO ADD TO A PLAYLIST

(71) Applicant: Google Inc., Mountain View, CA (US)

(72) Inventors: Jason Robert Richard Sanio, Mountain View, CA (US); Courtney Hampson, Mountain View, CA (US)

(73) Assignee: Google Inc., Mountain View, CA (US)

(21) Appl. No.: 14/163,980

(22) Filed: Jan. 24, 2014

(51) Int. Cl. G06F 17/30

(52) U.S. Cl. CPC G06F 17/30053

(57) ABSTRACT

A method for providing playlist content item recommendations is disclosed. The method includes receiving, at a processing device, a playlist content item recommendation generation request, receiving, at the processing device, a playlist title, generating, at the processing device, one or more playlist content item recommendations for a playlist using the playlist title, and providing, by the processing device, one or more of the generated playlist content item recommendations.

### TECHNICAL FIELD

This disclosure relates to the field of content sharing platforms and, in particular, to providing playlist content item recommendations.

### BACKGROUND

On the Internet, social networks allow users to connect to and share information with each other. Many social networks include a content sharing aspect that allows users to upload, view, and share content, such as video content, image content, audio content, and so on. Other users of the social network may comment on the shared content, discover new content, locate updates, share content, and otherwise interact with the provided content. The shared content may include content from professional content creators, e.g., movie clips, TV clips, and music videos, as well as content from amateur content creators, e.g., video blogging and short original videos.

Content sharing platforms allow users to create playlists of the content maintained by the content sharing platform. The playlist feature of the content sharing platform allows users to group their favorite content items together in a single location for playback. However, in order to add items to a playlist a user typically should either navigate to and/or access a content item and then request that the content item be added to a playlist, or provide the Uniform Resource Locator (URL) of a content item that is to be added to a playlist.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one implementation, a method for providing playlist content item recommendations is disclosed. The method includes receiving, at a processing device, a playlist content item recommendation generation request. The method further includes receiving, at the processing device, a playlist title. The method further includes generating, at the processing device, one or more playlist content item recommendations for a playlist using the playlist title. The method further includes providing, by the processing device, one or more of the generated playlist content item recommendations.

In some implementations, the method also includes receiving, at the processing device, one or more acceptances of one or more of the playlist content item recommendations and generating, at the processing device, one or more additional playlist content item recommendations, wherein generation takes into account the acceptances. In some implementations, the method also includes receiving, at the processing device, indication of one or more playlist content item additions which were not subject of said recommendations and generating, at the processing device, one or more additional playlist content item recommendations, wherein generation takes into account the playlist content item additions.

Furthermore the method, in some implementations, also includes receiving, at the processing device, indication of one or more playlist content item deletions, wherein the deleted content items correspond to content items which were subject of said recommendations and generating, at the processing device, one or more additional playlist content item recommendations, wherein generation takes into account the deletions. The method, in some implementations, also includes receiving, at the processing device, indication of one or more playlist content item deletions, wherein the deleted content items correspond to content items which were not subject of said recommendations and generating, at the processing device, one or more additional playlist content item recommendations, wherein generation takes into account the deletions.

What is more the method, in some implementations, also includes receiving, at the processing device, an updated playlist title, and generating, at the processing device, one or more additional playlist content item recommendations, wherein generation takes into account the updated title.

Still further the method, in some implementations, also includes generation further taking into account one or more of title metadata of one or more content items, description metadata of one or more content items, genre metadata of one or more content items, keyword metadata of one or more content items, user comment metadata regarding one or more content items, transcript metadata of one or more content items, title metadata of one or more playlists containing one or more content items, or description metadata of one or more playlists containing one or more content items.

Additionally, the method, in some implementations also includes receiving, at the processing device, one or more acceptances of one or more of the playlist content item recommendations and generating, at the processing device, one or more non-recommendation-accepting-user playlist content item recommendations, wherein generation takes into account the acceptances.

In another implementation, a method for providing playlist content item recommendations is disclosed. The method includes receiving, at a processing device, a playlist content item recommendation generation request. The method further includes receiving, at the processing device, a playlist description. The method further includes generating, at the processing device, one or more playlist content item recommendations for a playlist using the playlist description. The method further includes providing, by the processing device, one or more of the generated playlist content item recommendations.

In some implementations, the method also includes receiving, at the processing device, one or more acceptances of one or more of the playlist content item recommendations and generating, at the processing device, one or more additional playlist content item recommendations, wherein generation takes into account the acceptances. In some implementations, the method also includes receiving, at the processing device, indication of one or more playlist content item additions which were not subject of said recommendations and generating, at the processing device, one or more additional playlist content item recommendations, wherein generation takes into account the playlist content item additions.

Furthermore the method, in some implementations, also includes receiving, at the processing device, indication of one or more playlist content item deletions, wherein the deleted content items correspond to content items which were subject of said recommendations and generating, at the processing device, one or more additional playlist content item recommendations, wherein generation takes into account the deletions. The method, in some implementations, also includes receiving, at the processing device, indication of one or more playlist content item deletions, wherein the deleted content items correspond to content items which were not subject of said recommendations and generating, at the processing device, one or more additional playlist content item recommendations, wherein generation takes into account the deletions.

What is more the method, in some implementations, also includes receiving, at the processing device, an updated playlist description, and generating, at the processing device, one or more additional playlist content item recommendations, wherein generation takes into account the updated description.

Still further the method, in some implementations, also includes generation further taking into account one or more of title metadata of one or more content items, description metadata of one or more content items, genre metadata of one or more content items, keyword metadata of one or more content items, user comment metadata regarding one or more content items, transcript metadata of one or more content items, title metadata of one or more playlists containing one or more content items, or description metadata of one or more playlists containing one or more content items.

Additionally, the method, in some implementations also includes receiving, at the processing device, one or more acceptances of one or more of the playlist content item recommendations and generating, at the processing device, one or more non-recommendation-accepting-user playlist content item recommendations, wherein generation takes into account the acceptances.

In additional implementations, computing devices for performing the operations of the above described implementations are also disclosed. Additionally, in implementations of the disclosure, a computer readable storage media stores methods for performing the operations of the above described implementations.

### BRIEF DESCRIPTION OF THE DRAWINGS

The present disclosure is illustrated by way of example, and not by way of limitation, in the figures of the accompanying drawings.

FIG. 1 illustrates a system architecture for playlist creation and/or modification, according to an example.

FIG. 2 is a block diagram illustrating a playlist component and a generation component, according to an example.

FIG. 3 is a flow diagram illustrating a method of providing playlist content item recommendations, according to an example.

FIG. 4 is a flow diagram illustrating a method of generating playlist content item recommendations, according to an example.

FIG. 5 is an illustration of an approach for employing seed data in the generation of playlist content item recommendations, according to an example.

FIGS. 6A and 6B illustrate graphical user interfaces (GUIs) for playlist build, according to an example.

FIG. 7 is a block diagram illustrating a computer system, according to an example.

### DETAILED DESCRIPTION

A playlist may be a list and/or an order of different content items that can be viewed in sequential or shuffled order without interaction from the user. A media viewer (e.g., a media viewer application and/or a web browser) may play the content items on a playlist in the order in which the content items are listed on the playlist. A user may also transition between content items on a playlist. For example, a user may wait for the next content item on the playlist to play or may select a particular content item in the playlist.

Playlists allow for the grouping together of content items. Such grouping together provides benefits including facilitating the organization of content items into sensible groupings (e.g., groupings by artist, composer, genre, era, topic, or mood), facilitating users making each other aware of content items (e.g., through users creating playlists and then sharing those playlists with other users), and sparking discussion amongst users regarding content items (e.g., through users posting comments in response to playlists of other users and/or in response to content items thereof).

However, playlist creation and modification are typically bothersome tasks. In order to add items to a playlist (e.g., within the context of a content sharing platform) a user typically should either navigate to and/or access a content item and then request that the content item be added to a playlist, or provide the Uniform Resource Locator (URL) of a content item that is to be added to a playlist. A user—perhaps considering such navigation and/or access to be too time consuming, and/or considering URLs to be cumbersome-—may opt to neither create nor modify playlists despite his having a desire to take advantage of benefits which he would enjoy by doing so.

Set forth herein are examples of approaches by which users may create and/or modify playlists while being shielded from unpleasantries such as the ones discussed. According to an example, a user may in connection with a new or existing playlist receive recommendations of content items to add to the playlist. They user may then be able to, in a non-troublesome way, have one or more suggested content items added to the playlist (e.g., by the activation of buttons or other graphical user interface (GUI) elements or widgets).

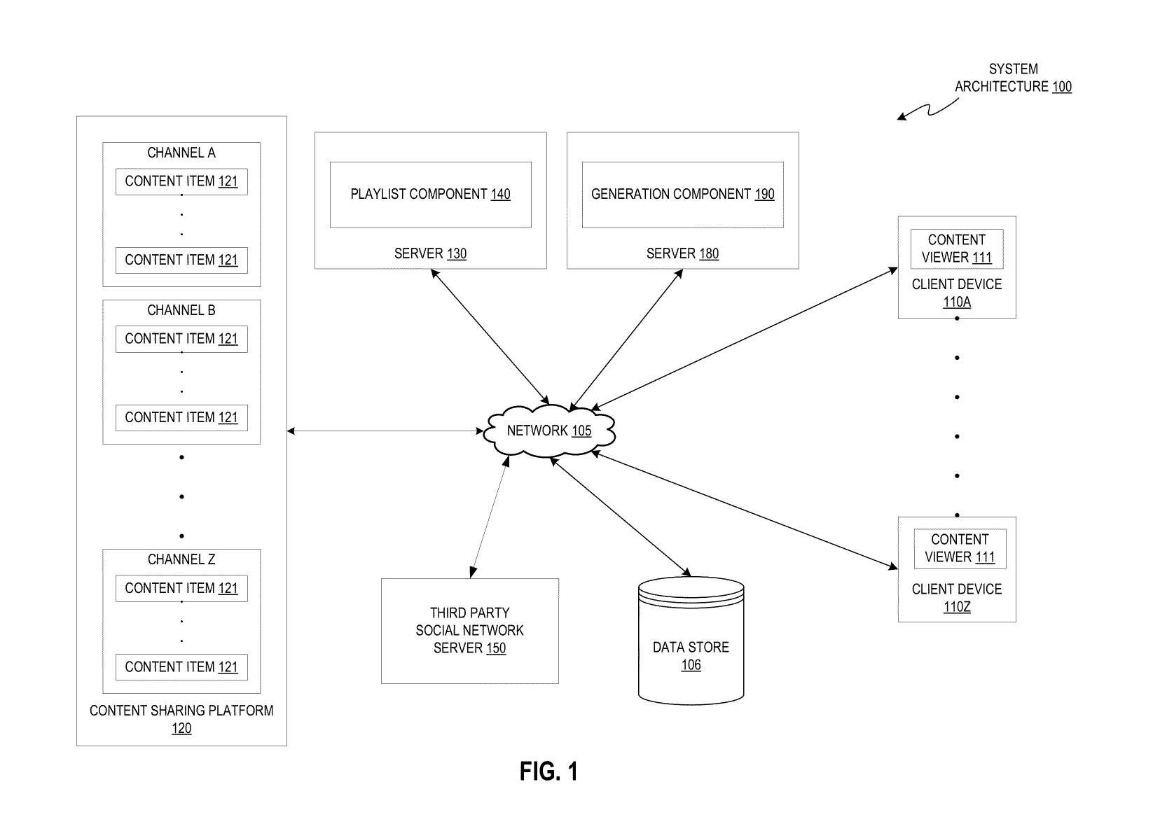

FIG. 1 illustrates an example system architecture 100 for playlist creation and/or modification. The system architecture 100 includes client devices 110A through 110Z, a network 105, a data store 106, a content sharing platform 120, a server 130, and a server 180. According to an example, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. According to an example, the data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers).

The client devices 110A through 110Z may each include computing devices such as personal computers (PCs), laptops, mobile phones, smart phones, tablet computers, netbook computers etc. In some implementations, client device 110A through 110Z may also be referred to as “user devices.” Each client device includes a content viewer 111. In one implementation, the content viewers 111 may be applications that allow users to view content, such as images, videos, web pages, documents, etc. For example, the content viewer 111 may be a web browser that can access, retrieve, present, and/or navigate content (e.g., web pages such as Hyper Text Markup Language (HTML) pages, digital media items, etc.) served by a web server. The content viewer 111 may render, display, and/or present the content (e.g., a web page, a content viewer) to a user. The content viewer 111 may also display an embedded media player (e.g., a Flash® player or an HTML5 player) that is embedded in a web page (e.g., a web page that may provide information about a product sold by an online merchant). In another example, the content viewer 111 may be a standalone application that allows users to view digital content items (e.g., digital videos, digital images, electronic books, etc.).

The content viewers 111 may be provided to the client devices 110A through 110Z by the server 130 and/or content sharing platform 120. For example, the content viewers 111 may be embedded media players that are embedded in web pages provided by the content sharing platform 120. In another example, the content viewers 111 may be applications (e.g., mobile apps) that are downloaded from the server 130.

In general, functions described in one implementation as being performed by the content sharing platform 120 can also be performed on the client devices 110A through 110Z in other implementations if appropriate. In addition, the functionality attributed to a particular component can be performed by different or multiple components operating together. The content sharing platform 120 can also be accessed as a service provided to other systems or devices through appropriate application programming interfaces, and thus is not limited to use in websites.

According to an example, the content sharing platform 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to content items and/or provide the content items to the user. For example, the content sharing platform 120 may allow a user to consume, upload, search for, approve of (“like”), dislike, and/or comment on content items. The content sharing platform 120 may also include a website (e.g., a webpage) that may be used to provide a user with access to the content items.

The content sharing platform 120 may include multiple channels (e.g., channels A through Z). A channel can be data content available from a common source or data content having a common topic or theme. The data content can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. Once a user subscribes to a channel, the user can be presented with information from the channel's activity feed. If a user subscribes to multiple channels, the activity feed for each channel to which the user is subscribed can be combined into a syndicated activity feed. Information from the syndicated activity feed can be presented to the user.

Each channel may include one or more content items 121. Examples of a content item 121 can include, and are not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. In some implementations, content item 121 may also referred to as a media item.

A content item 121 may be consumed via the Internet and/or via a mobile device application. As used herein, “media,” “content item,” “online content item,” “digital media,” “digital content item,” “media,” and “media item” can include an electronic file that can be executed or loaded using software, firmware or hardware configured to present the digital content item to an entity. In one implementation, the content sharing platform 120 may store the content items 121 using the data store 106.

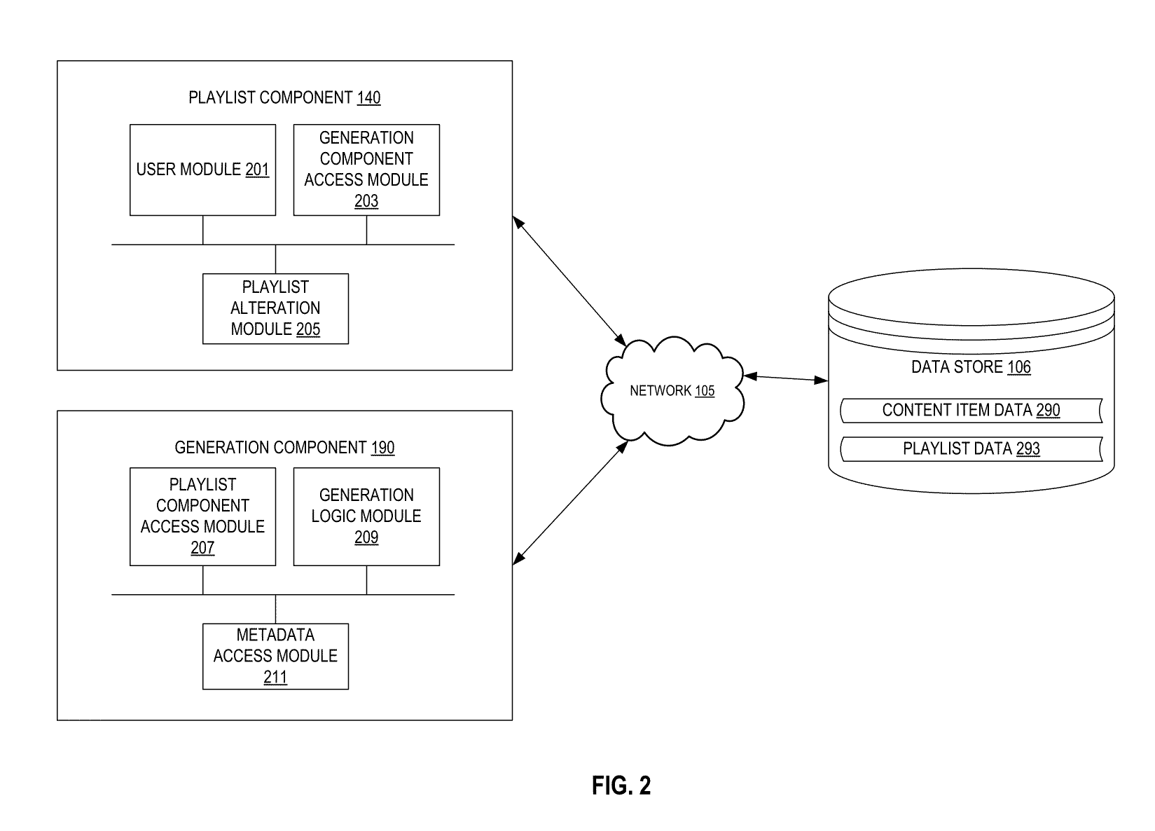

According to an example, server 130 and server 180 may each be one or more computing devices (e.g., a rackmount server, a server computer, etc.). Server 130 and/or server 180 may, according to an example, be included in the content sharing platform 120. The server 130 may include a playlist component 140. The server 180 may include a generation component 190. Playlist component 140 and/or generation component 190 may, according to an example, interact with content sharing platform 120 and/or with other third party social network servers 150. Examples of playlist component 140 and generation component 190 are discussed in more detail below in conjunction with FIG. 2.

Although various examples set forth herein are discussed in terms of content sharing platforms and/or promoting social network sharing of a content item on the content sharing platform, that which is set forth herein may also be applied, for instance, to any type of social network providing connections between users. Moreover, that which is set forth herein is not limited to content sharing platforms that provide channel subscriptions to users.

In situations in which the systems discussed herein collect personal information about users, or may make use of personal information, the users may be provided with an opportunity to control whether the content sharing platform 120 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 120.

FIG. 2 is an example block diagram illustrating playlist component 140, generation component 190, network 105, and data store 106. In accordance with an example, playlist component 140 includes user module 201, generation component access module 203, and playlist alteration module 205. Generation component 190, in accordance with an example, includes playlist component access module 207, generation logic module 209, and metadata access module 211. A greater or fewer quantity of components may be included in either or both of playlist component 140 and generation component 190 without loss of generality. For example, two of the modules may be combined into a single module, or one of the modules may be divided into two or more modules. One or more of the modules may, according to an example, reside on different computing devices (e.g., different server computers).

The playlist component 140 and generation component 190 are each communicatively coupled to the data store 106. For example, these components may be coupled to the data store 106 via a network (e.g., via network 105). The data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers). The data store 106 includes content item data (e.g., metadata) 290 and playlist data 293.

Turning to playlist component 140, user access module 201 may perform operations including receiving user requests for playlist content item recommendations and determining which—if any—of recommended content items are to be added to an at-hand playlist. Generation component access module 203 may perform operations including sending recommendation generation requests to generation component 190 and receiving recommendations from generation component 190. Playlist alteration module 205 may perform operations including adding to the playlist content items in accordance with suggestions which have been accepted. In implementing the addition, playlist alteration module 205 may interact with playlist data 293 of data store 106. The functionality of playlist component 140 is discussed in greater detail herein.

Turning to generation component 190, playlist component access module 207 may perform operations including receiving recommendation generation requests from playlist component 140 and sending recommendations to playlist component 140. Generation logic module 209 may perform operations including generating playlist content item recommendations. In generating the recommendations generation logic module 209 may interact with content item data 290 via metadata access module 211. The functionality of generation component 190 is discussed in greater detail herein.

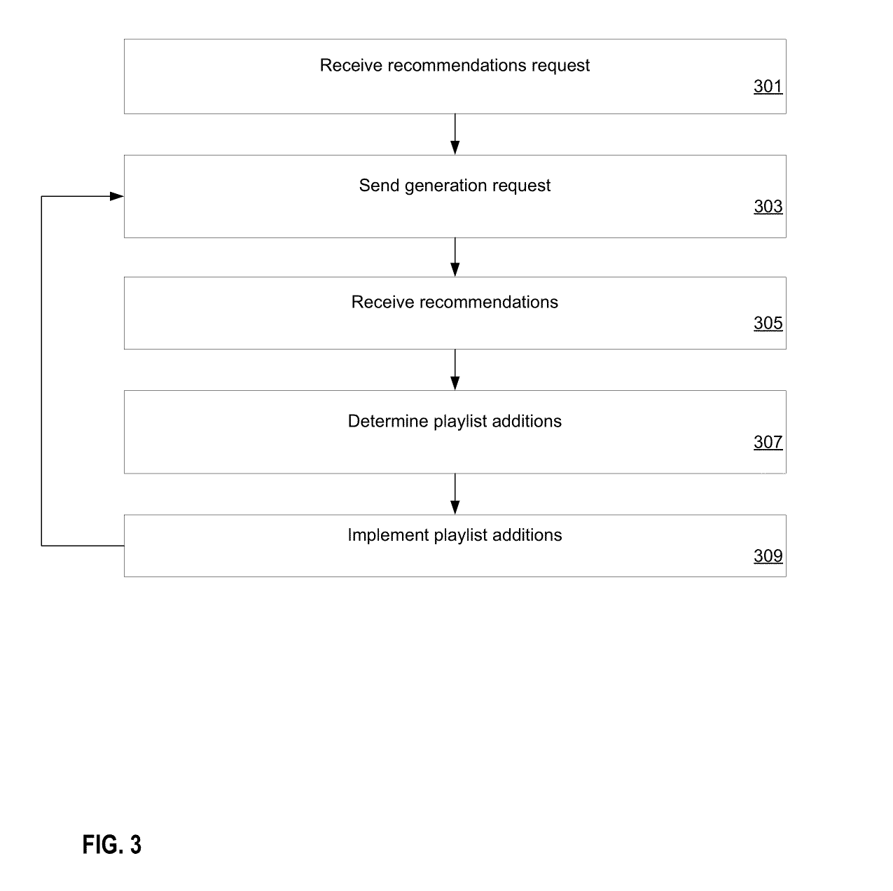

FIG. 3 illustrates a flow diagram of one example of a method of providing playlist content item recommendations (e.g., video or audio recommendations). The method may be performed by processing logic that comprises hardware (e.g., circuitry, dedicated logic, programmable logic, microcode, etc.), software (e.g., instructions run on a processing device to perform hardware simulation or instructions run on a processing device without the performance of hardware simulation), or a combination thereof. As one example, the method may be performed by a playlist component running on a computing device (e.g., playlist component 140 running on server 130).

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 3, at block 301 the processing logic may receive a request for playlist content item recommendations. The request may be received from a content viewer running on a computing device (e.g., content viewer 111 running on one of client devices 110A-110Z) and may be initiated by a user of the computing device.

The request may, for instance, include information employable as seed data for the generation of playlist content item recommendations. The request may, for instance, not so include seed data. Examples of such seed data include playlist title, playlist description, and one or more playlist entries (e.g., via metadata corresponding to the playlist entries). It is noted that playlist title, playlist description, and/or playlist entries may be referred to as playlist information.

As one example the request may be received in connection with an existing playlist. As another example the request may be received in connection with the creation of a new playlist.

Turning to the request being received in connection with an existing playlist, the existing playlist may include information employable as seed data (e.g., a title of the playlist, a description of the playlist, and/or one or more playlist entries). In the alternative, the existing playlist may not include any information employable as seed data. A user might (e.g., via a graphical user interface (GUI) provided by playlist component 140 and displayed by content viewer 111) indicate a desire to receive content item recommendations for the playlist. The user might do so by activating a GUI element or widget (e.g., a button or a hyperlink) labeled to specify or otherwise indicating that activating the element or widget will serve to lodge a request for content item recommendations. As examples, the element or widget might be labeled “receive content item recommendations,” “get suggestions,” or “populate playlist.” With the user's activation of the element or widget, a request for playlist content item recommendations may be dispatched (e.g., to playlist component 140). Where the existing playlist includes information employable as seed data, that information may be included in the request. As another example, the request for playlist content item recommendations may be dispatched (e.g., to playlist component 140) without an explicit indication by the user.

Turning to the request being received in connection with the creation of a new playlist, a user might (e.g., via a GUI provided by playlist component 140 and displayed by content viewer 111) specify information employable as seed data (e.g., a title for the new playlist, a description for the new playlist, and/or one or more entries for the new playlist). In the alternative, the user might not specify any information employable as seed data. The user might (e.g., via a GUI provided by playlist component 140 and displayed by content viewer 111) indicate a desire to establish the new playlist. The user might do so by activating a GUI element or widget (e.g., a button or a hyperlink) labeled to specify that activating the element or widget will serve to establish the new playlist. As examples, the element or widget might be labeled “done” or “set up playlist.”

As one example, with the user's activation of the element or widget a request to establish the playlist may be dispatched (e.g., to playlist component 140) and a request for playlist content item recommendations may be dispatched (e.g., to playlist component 140). Where the user specified information employable as seed data, that information may be included in the request for recommendations. As another example, with the user's activation of the element or widget a combined request may be dispatched (e.g., to playlist component 140) which serves both to request establishment of the playlist and to request playlist content item recommendations. Where the user specified information employable as seed data, that information may be included in the combined request. As another example the request for playlist content item recommendations may be dispatched (e.g., to playlist component 140) without an explicit indication by the user. For instance, the request might be dispatched in response to the user having indicated a title for the playlist, a description for the playlist, and/or one or more entries for the new playlist.

At block 303, the processing logic may send to generation component 190 a request for the generation of playlist content item recommendations. Where the processing logic received seed data, some or all of the seed data may be included in the request. Where the processing logic did not receive seed data, the request may include no seed data. The request may be sent via interprocess communication (e.g., via Simple Object Access Protocol (SOAP) or eXtensible Markup Language-Remote Procedure Call (XML-RPC)). As an alternative, such seed data might be sent separately from the request. One or more adjustment factors may be included in and/or sent separately from the request. Adjustment factors are discussed in greater detail hereinbelow.

At block 305, the processing logic may receive from generation component 190 (e.g., via interprocess communication) one or more playlist content item recommendations. Alternatively, the processing logic may generate playlist content item recommendations without any involvement of another component such as generation component 190, and operations performed at blocks 303 and 305 may be replaced with the generation of playlist content item recommendations.

At block 307 the processing logic may determine which—if any—of the recommended content items should be added to the at-hand playlist. The processing logic may (e.g., via a GUI provided by playlist component 140 and displayed by content viewer 111) present the playlist content item recommendations to the user as potential additions to the playlist. For example, displayed in connection with each of the playlist content item recommendations may be a GUI element or widget (e.g., a button or hyperlink) labeled to specify that activating the element or widget will cause the corresponding content item to be added to the playlist (e.g., the element or widget might be labeled “add to playlist” or “yes”).

As one example, the processing logic may act to explicitly determine whether or not the user rejects any of the playlist content item recommendations. Displayed in connection with each of the playlist content item recommendations may be a GUI element or widget (e.g., a button or hyperlink) labeled to specify that activating the element or widget will serve to reject the corresponding content item (e.g., the element or widget might be labeled “do not add to playlist” or “no”). As another example, the processing logic may determine the user to have rejected a given playlist content item recommendation in the case where the user has not, within a given period of time (e.g., a period of time set during a configuration), acted to add the item to the playlist. As an additional example, the processing logic may not act to determine whether or not the user rejects any of the playlist content item recommendations (e.g., the processing logic may only consider content item acceptances). The processing logic may act to inform (e.g., via interprocess communication) generation component 190 of determined acceptances and/or rejections of content item recommendations.

At block 309 the processing logic may, where the user has indicated that one or more recommended content items should be added to the playlist, implement the addition. The processing logic may do so by modifying a corresponding data structure held in data store 106 (e.g., playlist data 293) and/or in another location (e.g., a data store of server 130), and/or by updating a display corresponding to the playlist (e.g., via a GUI provided by playlist component 140 and displayed by content viewer 111).

The processing logic may then return to block 303 and send (e.g., via interprocess communication) to generation component 190 a further request for generation of playlist content item recommendations. One or more adjustment factors (e.g., acceptances and/or rejections of content item recommendations) may be included in and/or sent separately from the request. The processing logic may then proceed to cycle through the operations discussed in connection with blocks 305-309, including performance of the discussed return to block 303.

According to an example, where the processing logic receives new playlist content item recommendations subsequent to a return to block 303, the new recommendations may be presented to the user along with those of the most-recently presented recommendations which have neither been accepted nor rejected by the user. For instance, where the most-recently presented recommendations were content items A, B, C, D, and E, the user accepted recommendations A and E, the user rejected recommendation C, and the new recommendations are content items F and G, the following may transpire. Presented to the user may be recommendations B, D, F, and G. As such, the user is re-presented recommendations B and D which the user had neither accepted nor rejected, and further presented new recommendations F and G.

According to another example, the user may only be presented the new recommendations. As such, returning to the user's acceptance of recommendations A and E, and rejection of recommendation C, the following may transpire. Presented to the user may be the new recommendations, to wit F and G. It is noted that the user might be presented with previously-presented recommendations in the case where such previously-presented recommendations are among the new recommendations. For instance, taking the new recommendations to instead be content items B, F, and G, presented to the user may be content items B, F, and G.

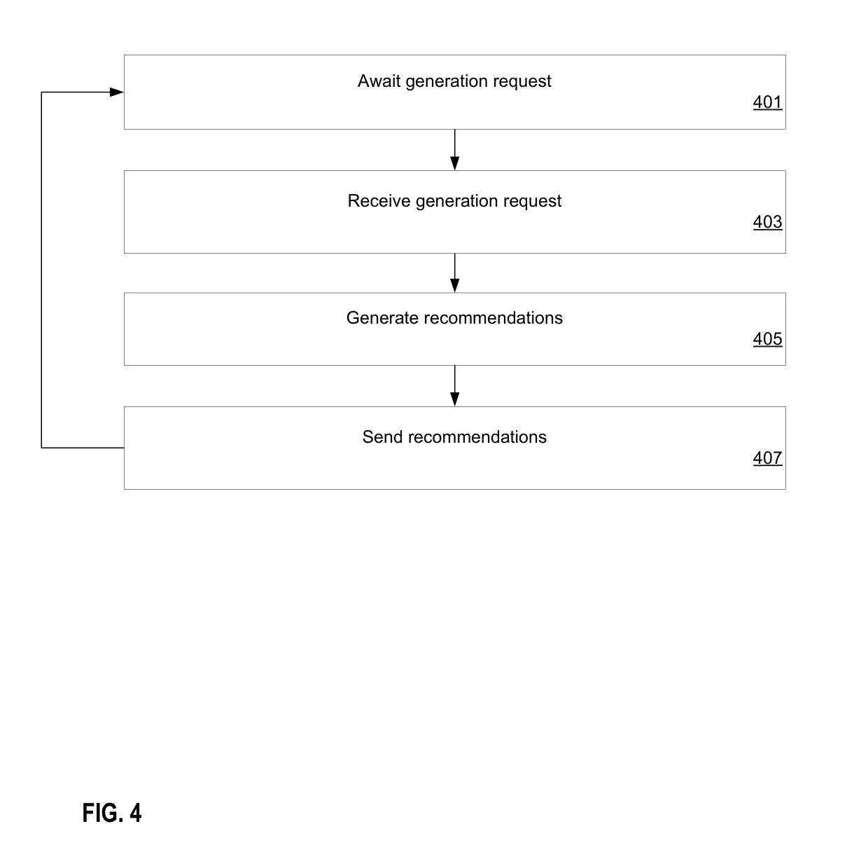

FIG. 4 illustrates a flow diagram of one example of a method of generating playlist content item recommendations. The method may be performed by processing logic that comprises hardware (e.g., circuitry, dedicated logic, programmable logic, microcode, etc.), software (e.g., instructions run on a processing device to perform hardware simulation or instructions run on a processing device without the performance of hardware simulation), or a combination thereof. As one example, the method may be performed by a generation component running on a computing device (e.g., generation component 190 running on server 180).

Referring to FIG. 4, at block 401 processing logic may await the receipt of a request for the generation of playlist content item recommendations. At block 403, the processing logic may receive such a request from playlist component 140. The request may be received via interprocess communication. As one example the request may include seed data. As another example the request may include one or more adjustment factors (e.g., acceptances of content item recommendations and/or rejections of content item recommendations). As yet another example, the request may include neither. As an alternative, such seed data and/or adjustment factors might be received separately from the request.

As noted, there may be performance of block 303 in which there is return to block 303 subsequent to a performance of block 309. Where there is receipt of acceptance indication and/or rejection indication, the acceptance indication and/or rejection indication might be received in connection with such a non-initial performance of block 303. As also noted, there may be initial performance of block 303 prior to such a return. Where there is receipt of seed data, the seed data might be received in connection with such an initial performance of block 303

At block 405, the processing logic may generate one or more playlist content item recommendations. In performing the generation, the processing logic may employ either or both of seed data and one or more adjustment factors. As one example, the processing logic might take into account both seed data and one or more adjustment factors. As another example, the processing logic might take into account one or more adjustment factors but not take into account seed data. Such might transpire where the processing logic did not receive seed data.

Where the processing logic did receive seed data, turning to the employ of such seed data the processing logic, as an example, may have access to a data pool containing metadata regarding one or more content items (e.g., content item data 290). Examples of such content item metadata include title, description, genre, keyword, user comments (e.g., posted in response to the content item), transcript (e.g., a user-created transcript or a transcript created by processing logic which performs speech recognition), title of a playlist (e.g., a playlist created by a different user) which contains the content item, and description of a playlist (e.g., a playlist created by a different user) which contains the content item. As one example, where the processing logic is aware of suggestions which have been accepted by the user, the corresponding content items might not be subjected to the seed data employ.

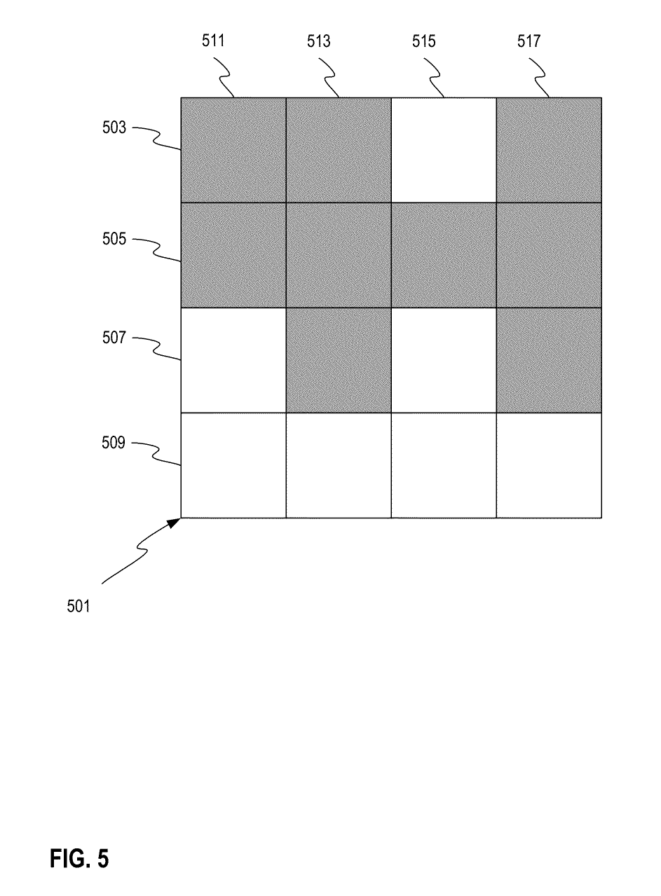

FIG. 5 illustrates one example of an approach for employing seed data in the generation of playlist content item recommendations. As one example, the approach may be performed by a generation component running on a computing device (e.g., generation component 190 running on server 180). Shown in FIG. 5 are, for a content item 501, seed data 503-509 and content item metadata 511-517. According to the example of FIG. 5, a determination may be made as to whether or not content item 501 should be considered a match for seed data 503-509.

As an illustration, suppose that seed data 503 is the playlist title “Mozart concertos.” Suppose further that content item metadata 511-517 for content item 501 are title (511) “Violin Concerto Number Five,” description (513) “A Concerto in A major,” the user comment (515) “The master at his awesome best,” and that the content item is included in a playlist, entitled “Mozart,” of another user (517).

As illustrated by darkened boxes of FIG. 5, seed data 503 might be considered to match content item 501 with respect to metadata 511, 513, and 519 but, as illustrated by the undarkened box of FIG. 5, be considered to not match content item 501 with respect to metadata 515. In like vein, as illustrated by the darkened boxes of FIG. 5 seed data 505 might be considered to match content item 501 with respect to metadata 511-517. In further like vein, as indicated by the darkened boxes of FIG. 5 seed data 507 might be considered to match content item 501 with respect to metadata 513 and 517 but, as illustrated by the undarkened boxes of FIG. 5, be considered to not match content item 501 with respect to metadata 511 and 515. In additional like vein, as indicated by the undarkened boxes of FIG. 5 seed data 507 might be considered to not match content item 501 with respect to metadata 511-517.

As an example, a content item might be considered to be a match for at-hand seed data in the case where at least a certain percentage of the possible seed data-metadata matches occur (e.g., considering FIG. 5 where at least a certain percentage of the boxes are darkened). As another example, a content item might be considered to be a match for at-hand seed data in the case where at least a threshold quantity of seed data-metadata matches occur (e.g., considering FIG. 5 where at least a certain number of boxes are darkened). Such percentage and/or threshold quantity might be set during a configuration.

Suppose that a content item is considered a match where at least 50% of the possible seed data-metadata matches occur. For the example of FIG. 5, nine out of the possible sixteen seed data-metadata matches occur. As such, content item 501 would be considered a match for seed data 503-509. On the other hand, suppose that a content item is considered a match where a threshold quantity of ten seed data-metadata matches occur. For the example of FIG. 5 as nine seed data-metadata matches occur content item 501 would not be considered to be a match for seed data 503-509.

As another illustration, suppose that a given seed data is the metadata element genre for an existing playlist entry, and that the element is set as “classical.” Suppose further that for a content item under consideration the metadata element genre is set to “classical.” The seed data might be considered to match the content item under consideration with respect to genre metadata.

Turning to the employ of adjustment factors, the processing logic may consider the metadata of one or more content items. Where the processing logic received seed data, the processing logic may apply the adjustment factors to those content items which were found to match that seed data. Where the processing logic did not receive seed data, the processing logic may apply the adjustment factors to all pool content. As one example, where the processing logic is aware of suggestions which have been accepted by the user, the corresponding content items might not be subjected to the adjustment factor employ. As another example, where the processing logic is aware of suggestions which have been accepted by the user, the corresponding content items might nevertheless be subjected to the adjustment factor employ.

As an example, the processing logic may assign a value to each of the content items to be considered (e.g., the content items which were found to match seed data or all pool content items). For instance, all such content items may be assigned the same value (e.g., zero may be assigned to each such content item). For instance, the value assigned to a content item may convey a property of and/or determination made with respect to the content item (e.g., the value assigned to a content item may correspond to the achieved percentage of possible seed-metadata matches).

The processing logic may then, with respect to each of the content items to be considered, apply one or more adjustment factors. Each such adjustment factor application may serve to raise, lower, or not change the content item's value. By so applying all of those adjustment factors which are to be applied, an end value for the content item could result.

As an illustration, suppose that a given content item is initially assigned a value of 5, the value being proportional to that content item's achieved percentage of possible seed-metadata matches. Suppose further that four adjustment factors are applied, with the application of the first adjustment factor raising the content item's value by 1, the application of the second adjustment factor raising the content item's value by 3, the application of the third adjustment factor lowering the content item's value by 2, and the application of the fourth adjustment factor not changing the content item's value. As such, the end value for the content item would be seven.

Having found an end value for each of the one or more content items to be considered, one or more of those content items might be selected as playlist content item recommendations. As one example, the content items with the top X end values might be selected as playlist content item recommendations (e.g., with X set to three, the content items having the top three end values might be selected). As another example, those content items whose end values met a set threshold value Y might be selected as playlist content item recommendations (e.g., with Y set to six, those content items achieving end values of six or higher could be selected). The values for X and Y might be set during a configuration.

As noted, the application of an adjustment factor to a content item may serve to raise, lower, or not change that content item's value. Examples of adjustment factors and the application of those adjustment factors will now be discussed. It is noted that discussed similarity of metadata might, for instance, refer to at least a certain percentage the possible metadata-metadata matches occurring and/or to at least a threshold quantity of the possible metadata-metadata matches occurring. Determination of metadata-metadata matches may, for instance, be performed in a manner in line with that discussed hereinabove with respect to determination of seed data-metadata matches. Determination of metadata-metadata matches might, for instance, be performed in another way. It is additionally noted that the amounts by which content item values are, with the application of a given adjustment factor, raised and/or lowered might, for instance, be set during a configuration. Moreover, discussed quantities, percentages, and the like may, for instance, be set during a configuration.

One example adjustment factor is the at-hand user's acceptance and/or rejection of a given playlist content item recommendation made in connection with the at-hand playlist. Where the content item under consideration is indicated (e.g., by corresponding metadata) to be similar to a content item for which recommendation was accepted, application of the adjustment factor may serve to raise the value of the content item under consideration. Alternately or additionally, where the content item under consideration is indicated (e.g., by corresponding metadata) to not be similar to a content item for which recommendation was accepted, the application of the adjustment factor may serve to lower the value of the content item under consideration.

Further alternately or additionally, where the content item under consideration is indicated (e.g., by corresponding metadata) to be similar to a content item for which recommendation was rejected, the application of the adjustment factor may serve to lower the value of the content item under consideration. Still further alternately or additionally, where the content item under consideration is indicated (e.g., by corresponding metadata) to not be similar to a content item for which recommendation was rejected, the application of the adjustment factor may serve to raise the value of the content item under consideration.

Another example adjustment factor is a given content item which was added to the playlist by the at-hand user without having been the subject of a recommendation. Where the content item under consideration is indicated (e.g., by corresponding metadata) to be similar to the added content item, application of the adjustment factor may serve to raise the value of the content item under consideration. Alternately or additionally, where the content item under consideration is indicated (e.g., by corresponding metadata) to not be similar to the added content item, the application of the adjustment factor may serve to lower the value of the content item under consideration.

An additional example adjustment factor is another user's acceptance and/or rejection of a given playlist content item recommendation which was directed towards that other user. This adjustment factor might, for instance, be employed where the at-hand playlist is similar (e.g., as per corresponding metadata) to the playlist of the other user for which the recommendation was made. Where the content item under consideration is indicated (e.g., by corresponding metadata) to be similar to a content item for which recommendation was accepted by that other user, application of the adjustment factor may serve to raise the value of the content item under consideration. Alternately or additionally, where the content item under consideration is indicated (e.g., by corresponding metadata) to not be similar to a content item for which recommendation was accepted by that other user, the application of the adjustment factor may serve to lower the value of the content item under consideration.

Further alternately or additionally, where the content item under consideration is indicated (e.g., by corresponding metadata) to be similar to a content item for which recommendation was rejected by that other user, the application of the adjustment factor may serve to lower the value of the content item under consideration. Still further alternately or additionally, where the content item under consideration is indicated (e.g., by corresponding metadata) to not be similar to a content item for which recommendation was rejected by that other user, the application of the adjustment factor may serve to raise the value of the content item under consideration.

With further regard to this adjustment factor, it is noted that, according to an example, the magnitudes of such raises and/or lowerings might be smaller than if the concomitant acceptance or rejection had been made by the at-hand user rather than by another user. According to another example, such might not be the case.

Yet another example adjustment factor is the at-hand user's deletion from the playlist of a content item which had been added to the playlist in connection with that user's acceptance of a corresponding recommendation. Where the content item under consideration is indicated (e.g., by corresponding metadata) to be similar to the deleted content item, the application of the adjustment factor may serve to lower the value of the content item under consideration. Alternately or additionally, where the content item under consideration is indicated (e.g., by corresponding metadata) to not be similar to the deleted content item, the application of the adjustment factor may serve to raise the value of the content item under consideration. With further regard to this adjustment factor, it is noted that, according to an example, the magnitudes of such raises and/or lowerings might be larger than if the user had rejected the noted recommendation rather than having accepted it but then subsequently deleted the corresponding content item from the playlist. Such might, for instance, be implemented from the vantage point that such deletion represents a considered act by the user due to there being some passage of time between the suggestion acceptance and the content item deletion. According to another example, such a magnitude difference might not be implemented.

A further example adjustment factor is the at-hand user's deletion from the playlist of a content item which was added to the playlist by the at-hand user without having been the subject of a recommendation. Where the content item under consideration is indicated (e.g., by corresponding metadata) to be similar to the deleted content item, the application of the adjustment factor may serve to lower the value of the content item under consideration. Alternately or additionally, where the content item under consideration is indicated (e.g., by corresponding metadata) to not be similar to the deleted content item, the application of the adjustment factor may serve to raise the value of the content item under consideration. With further regard to this adjustment factor, it is noted that, according to an example, the magnitudes of such raises and/or lowerings might be larger than those of the adjustment factor of the at-hand user's deletion from the playlist of a content item which had been added to the playlist in connection with that user's acceptance of a corresponding recommendation. Such might, for instance, be implemented from the vantage point that both of the without-suggestive-assistance content item addition and the content item deletion represent fully user-conceived acts. According to another example, such a magnitude difference might not be implemented.

Yet another example adjustment factor is an access history (e.g., viewing history) for the at-hand user. Where the content item under consideration is indicated (e.g., by corresponding metadata) to be similar to a content item of the access history, application of the adjustment factor may serve to raise the value of the content item under consideration. Alternately or additionally, where the content item under consideration is indicated (e.g., by corresponding metadata) to not be similar to a content item of the access history, the application of the adjustment factor may serve to lower the value of the content item under consideration.

An additional example adjustment factor is another user's deletion from a playlist of the other user of a content item which had been added to that playlist in connection with that other user's acceptance of a corresponding recommendation which had been directed towards that other user. Where the content item under consideration is indicated (e.g., by corresponding metadata) to be similar to the deleted content item, the application of the adjustment factor may serve to lower the value of the content item under consideration. Alternately or additionally, where the content item under consideration is indicated (e.g., by corresponding metadata) to not be similar to the deleted content item, the application of the adjustment factor may serve to raise the value of the content item under consideration. This adjustment factor might, for instance, be employed where the at-hand playlist is similar (e.g., as per corresponding metadata) to the playlist of the other user. With further regard to this adjustment factor, it is noted that, according to an example, the magnitudes of such raises and/or lowerings might be smaller than if the concomitant recommendation acceptance and subsequent deletion had been made by the at-hand user rather than by another user. According to another example, such might not be the case.

A further example adjustment factor is an access history (e.g., viewing history) for another user with whom the at-hand user shares the playlist. Where the content item under consideration is indicated (e.g., by corresponding metadata) to be similar to a content item of the access history for the other user, application of the adjustment factor may serve to raise the value of the content item under consideration. Alternately or additionally, where the content item under consideration is indicated (e.g., by corresponding metadata) to not be similar to a content item of the access history for the other user, the application of the adjustment factor may serve to lower the value of the content item under consideration. With further regard to this adjustment factor, it is noted that, according to an example, the magnitudes of such raises and/or lowerings might be smaller than if the access history had been for the at-hand user rather than for the other user. According to another example, such might not be the case.

An additional example adjustment factor is that a playlist is being built (e.g., with suggestions being sought in connection with a new or existing playlist). Where the content item under consideration is indicated (e.g., by corresponding metadata) to be one often included in playlists (e.g., a content item found within a certain quantity of playlists and/or within a certain percentage of playlists), application of the adjustment factor may serve to raise the value of the content item under consideration. Alternately or additionally, where the content item under consideration is not indicated to be one often included in playlists, application of the adjustment factor may serve to lower the value of the content item under consideration.

Still another example adjustment factor is an updated title for the at-hand playlist. Where the content item under consideration is indicated (e.g., by corresponding metadata) to be similar to the updated title, application of the adjustment factor may serve to raise the value of the content item under consideration. Alternately or additionally, where the content item under consideration is indicated (e.g., by corresponding metadata) to not be similar to the updated title, the application of the adjustment factor may serve to lower the value of the content item under consideration.

A further example adjustment factor is an updated description for the at-hand playlist. Where the content item under consideration is indicated (e.g., by corresponding metadata) to be similar to the updated description, application of the adjustment factor may serve to raise the value of the content item under consideration. Alternately or additionally, where the content item under consideration is indicated (e.g., by corresponding metadata) to not be similar to the updated description, the application of the adjustment factor may serve to lower the value of the content item under consideration.

Yet another example adjustment factor involves whether or not the content item under consideration is indicated (e.g., by corresponding metadata) to be a popular content item (e.g., a content item found within a certain quantity of access histories (e.g., viewing histories) and/or within a certain percentage of access histories (e.g., viewing histories)). Where the content item under consideration is indicated to be popular, application of the adjustment factor may serve to raise the value of the content item under consideration. Alternately or additionally, where the content item under consideration is not indicated to be popular, application of the adjustment factor may serve to lower the value of the content item under consideration. It is noted that a popular content item might be referred to as a “trending” content item.

At block 407, the processing logic may send (e.g., via interprocess communication) one or more of the playlist content item recommendations to playlist component 140. The processing logic may then return to block 401 to once again await request receipt.

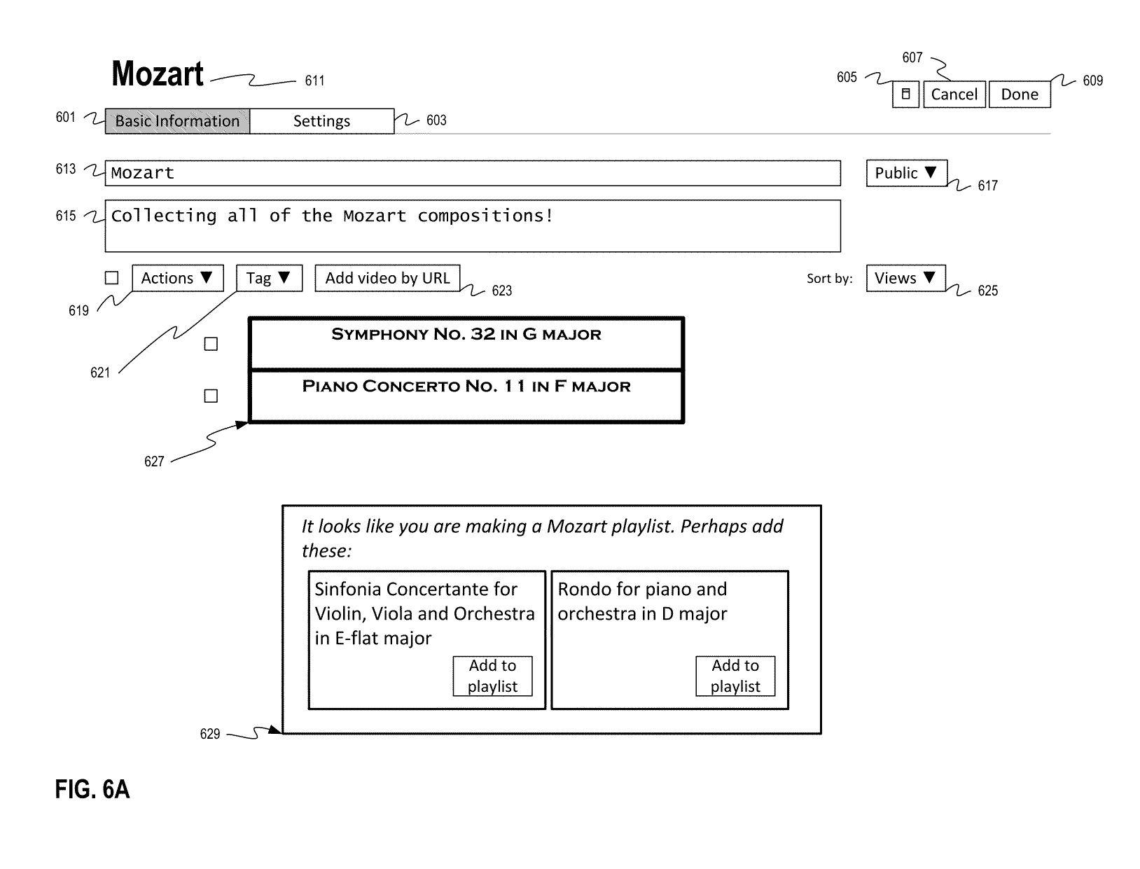

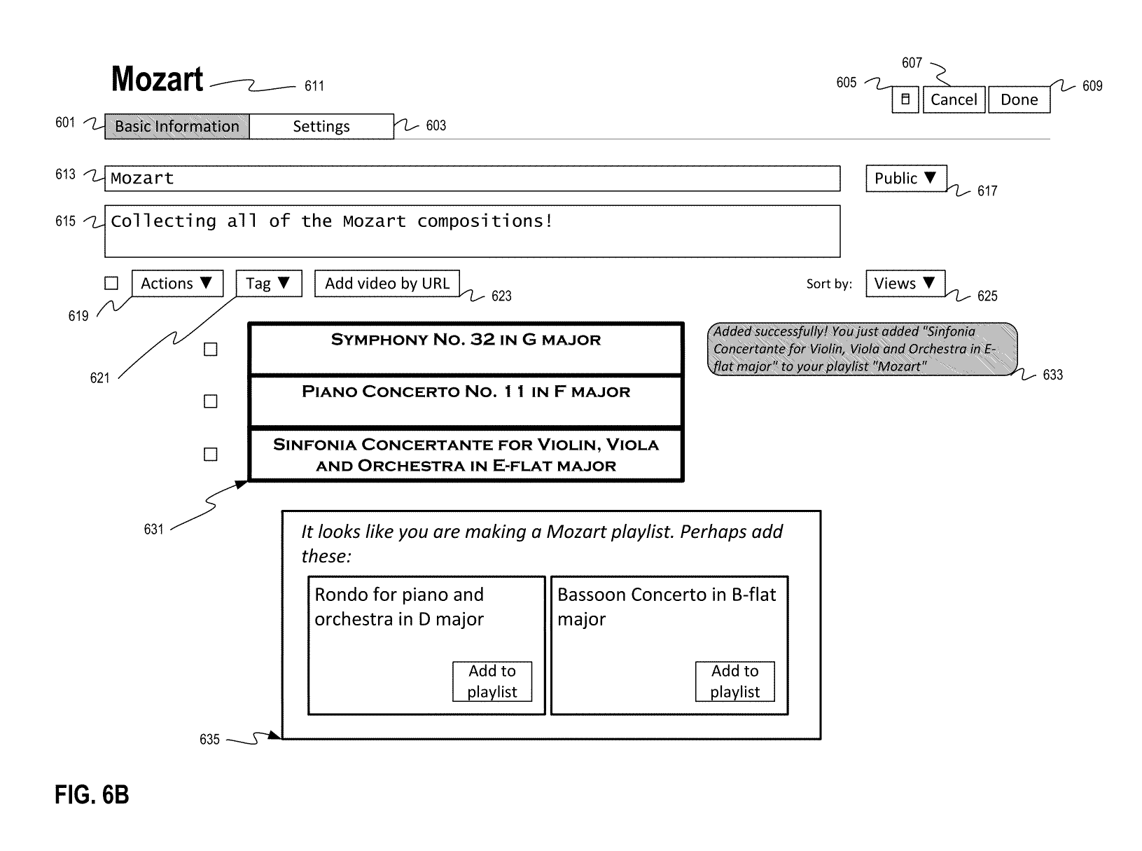

FIGS. 6A and 6B illustrate example GUIs for playlist build. Shown in FIGS. 6A and 6B are “Basic Information” tab element or widget 601 and “Settings” tab element or widget 603. Selection of “Basic Information” tab 601 may allow actions including editing the title of the playlist, editing the description of the playlist, adding content items to the playlist, deleting content items from the playlist, and/or indicating a privacy setting for the playlist. Such privacy settings may include “public” (e.g., available to all users and locatable via search), “private” (e.g., only available to the creator of the playlist), and/or “unlisted” (e.g., available to all users but neither findable via search nor posted on any content item channels of the creator of the playlist). Selection of “Settings” tab 603 may allow for actions including allowing or disallowing embedding of the playlist (e.g., embedding in webpages), modifying playlist “like” settings (e.g., settings corresponding to user approvals or disapprovals regarding the playlist), and/or designating whether or not the playlist is a series playlist (e.g., a playlist for which it is desired that users accessing one content item of the playlist be directed to other content items of the playlist and/or to the playlist). According to the example of FIGS. 6A and 6B the “Basic Information” tab has been selected.

Also shown in FIGS. 6A and 6B are button element or widget 605 which bears the icon of a garbage can, button element or widget 607 which bears the label “cancel,” and button element or widget 609 which bears the label “done.” Activation of element or widget 605 may result in deletion of the playlist, activation of element or widget 607 may result in canceling that which has been performed thus far by the user via employ of the GUI, and activation of element or widget 609 may allow the user to indicate that he has completed that which he intends to do via employ of the GUI. Further shown in FIGS. 6A and 6B is playlist title indication 611.

Further shown in FIGS. 6A and 6B are editable field element or widget 613, editable field element or widget 615, and pulldown element or widget 617. The employ of element or widget 613 may allow for editing a title of the playlist, the employ of element or widget 615 may allow for editing a description of the playlist, and the employ of element or widget 617 may allow for the indication of a privacy setting for the playlist (e.g., in accordance with the above-discussed privacy settings). Still further shown in FIGS. 6A and 6B are actions pulldown element or widget 619, tag pulldown element or widget 621, button element or widget 623 which bears the label “add video by URL,” and sort pulldown element or widget 625. The employ of element or widget 619 may allow for actions including moving one or more content items of the playlist to the top of the playlist, moving one or more content items of the playlist to the bottom of the playlist, and/or removing one or more content items from the playlist. The employ of element or widget 621 may allow for the specification of tags which serve to provide information describing the playlist. Such tags might be single word or multiword tags. The employ of element or widget 623 may allow for the addition of a content item to the playlist by specifying a Uniform Resource Locator (URL) which can be employed to access the content item. The employ of sort element or widget 625 may allow the specification of a sort order for the playlist. The sort order options might include sort in accordance with the number of accesses (e.g., views) experienced by each content item of the playlist (e.g., forward or reverse order according to quantity of views), the tiles of each content item of the playlist (e.g., forward or reverse alphabetical order), the creation and/or upload dates of each content item of the playlist (e.g., forward or reverse chronological order), and/or random order.

According to the example of FIGS. 6A and 6B, a new playlist is being created. Turning to FIG. 6A, the user has set the playlist title to “Mozart” (613) and has set the playlist description as “Collecting all of the Mozart compositions!” (615), has set the playlist privacy setting to “public” (617), and has set the sort order as “views.” Playlist title indication 611 displays “Mozart” in keeping with the user having set the playlist title to “Mozart.” Moreover in FIG. 6A, the user has added to the playlist content items “Symphony No. 32 in G major” and “Piano Concerto No. 11 in F major” without these content items having been the subject of a recommendation (627).

With further regard to FIG. 6A, presented to the user as potential additions to the playlist are the content items “Sinfonia Concertante for Violin, Viola and Orchestra in E-flat major” and “Rondo for piano and orchestra in D major” (629). Provided for each of these recommendations is a GUI button element or widget labeled “add to playlist,” the activation of which results in the corresponding content item being added to the playlist. Displayed along with the recommendations is the phrase “It looks like you are making a Mozart playlist. Perhaps add these:” In the example of FIG. 6A, the phrase includes the word “Mozart” in keeping with one or more of the playlist title having been set to “Mozart,” the playlist description having been set to “Collecting all of the Mozart compositions!,” and the user having added to the playlist content items which are Mozart compositions (e.g., as indicated by corresponding metadata), and the recommended content items being Mozart compositions (e.g., as indicated by corresponding metadata). As another example a phrase in this vein might characterize the playlist in other ways (e.g., in keeping with appropriate metadata other than composer and/or artist, say genre, keyword, or content item title).

Turning to FIG. 6B, the user has accepted the content item suggestion of “Sinfonia Concertante for Violin, Viola and Orchestra in E-flat major” by activating the corresponding button element or widget. As such, this content item has been added to the playlist (631). In keeping with this “Added successfully! You just added ‘Sinfonia Concertante for Violin, Viola and Orchestra in E-flat major’ to your playlist ‘Mozart’ ” is displayed to the user. Presented in FIG. 6B to the user as potential additions to the playlist are the content items “Rondo for piano and orchestra in D major” and “Bassoon Concerto in B-flat major” (635). As such, the accepted recommendation of “Sinfonia Concertante for Violin, Viola and Orchestra in E-flat major” is no longer presented to the user, the recommendation of “Rondo for piano and orchestra in D major” is re-presented to the user, and the recommendation of “Bassoon Concerto in B-flat major” is newly presented to the user.

Other locations and configurations of that which is set forth in FIGS. 6A and 6B (e.g., other locations and configurations of the GUI elements or widgets thereof) may also be employed.

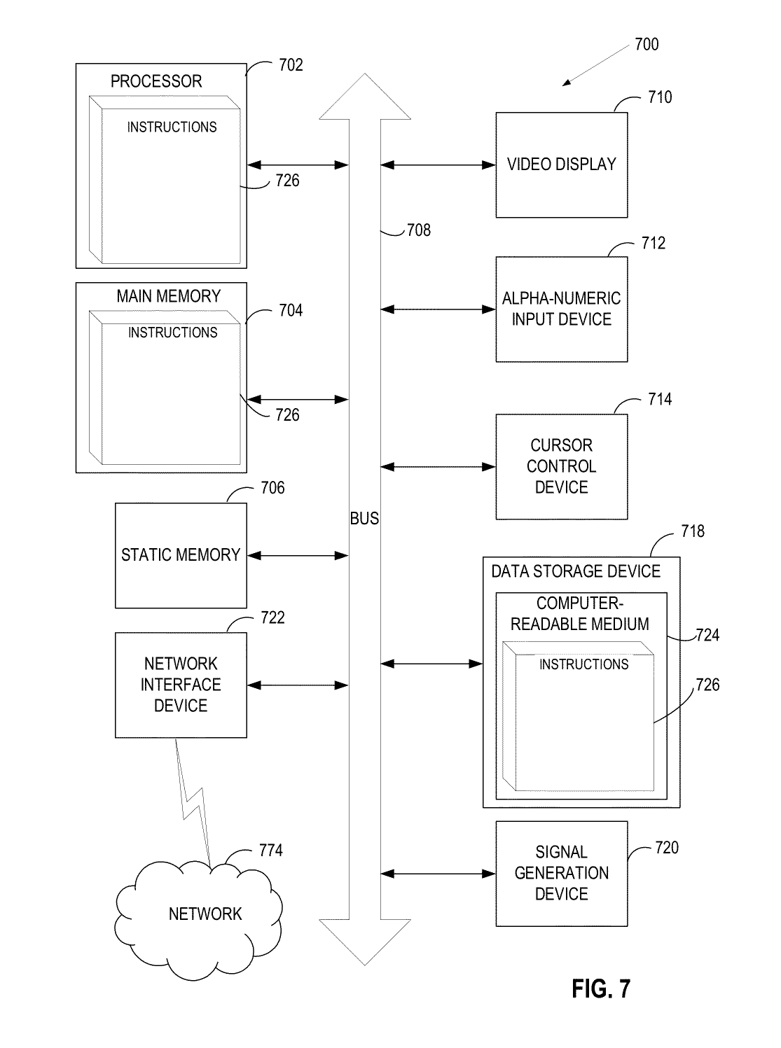

FIG. 7 illustrates a diagrammatic representation of an example of a machine in the form of a computer system 700 within which a set of instructions, for causing the machine to perform any one or more of the methodologies discussed herein, may be executed. In alternative examples, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 708.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 may also be one or more special-purpose processing devices such as an application specific integrated circuit (ASIC), a field programmable gate array (FPGA), a digital signal processor (DSP), network processor, or the like. The processor 702 is configured to execute instructions 726 for performing the operations and steps discussed herein.

The computer system 700 may further include a network interface device 722. The computer system 700 also may include a video display unit 710 (e.g., a liquid crystal display (LCD), a cathode ray tube (CRT), or a touch screen), an alphanumeric input device 712 (e.g., a keyboard), a cursor control device 714 (e.g., a mouse), and a signal generation device 720 (e.g., a speaker).

The data storage device 718 may include a computer-readable storage medium 724 on which is stored one or more sets of instructions 726 (e.g., software) embodying any one or more of the methodologies or functions described herein. The instructions 726 may also reside, completely or at least partially, within the main memory 704 and/or within the processor 702 during execution thereof by the computer system 700, the main memory 704 and the processor 702 also constituting computer-readable storage media. The instructions 726 may further be transmitted or received over a network 774 via the network interface device 722.

According to an example, the instructions 726 include instructions for a playlist component 140 and/or for a generation component 190 which may correspond, respectively, to their identically-named counterparts described herein, and/or to a software library containing methods that implement that which is discussed herein in connection with playlist component 140 and/or generation component 190. While the computer-readable storage medium 724 is shown in the example of FIG. 7 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the foregoing description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference herein to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, at a processing device, a playlist content item recommendation generation request;
receiving, at the processing device, a playlist title;
generating, at the processing device, one or more playlist content item recommendations for a playlist using the playlist title; and
providing, by the processing device, one or more of the generated playlist content item recommendations.

2. The method of claim 1, further comprising:
receiving, at the processing device, one or more acceptances of one or more of the playlist content item recommendations; and
generating, at the processing device, one or more additional playlist content item recommendations, wherein generation takes into account the acceptances.

3. The method of claim 1, further comprising:
receiving, at the processing device, indication of one or more playlist content item additions which were not subject of said recommendations; and
generating, at the processing device, one or more additional playlist content item recommendations, wherein generation takes into account the playlist content item additions.

4. The method of claim 1, further comprising:
receiving, at the processing device, indication of one or more playlist content item deletions, wherein the deleted content items correspond to content items which were subject of said recommendations; and
generating, at the processing device, one or more additional playlist content item recommendations, wherein generation takes into account the deletions.

5. The method of claim 1, further comprising:
receiving, at the processing device, indication of one or more playlist content item deletions, wherein the deleted content items correspond to content items which were not subject of said recommendations; and
generating, at the processing device, one or more additional playlist content item recommendations, wherein generation takes into account the deletions.

6. The method of claim 1, further comprising:
receiving, at the processing device, an updated playlist title; and
generating, at the processing device, one or more additional playlist content item recommendations, wherein generation takes into account the updated title.

7. The method of claim 1, wherein generation further takes into account one or more of:
title metadata of one or more content items;
description metadata of one or more content items;
genre metadata of one or more content items;
keyword metadata of one or more content items;
user comment metadata regarding one or more content items;
transcript metadata of one or more content items;
title metadata of one or more playlists containing one or more content items; or
description metadata of one or more playlists containing one or more content items.

8. The method of claim 1, further comprising:
receiving, at the processing device, one or more acceptances of one or more of the playlist content item recommendations; and
generating, at the processing device, one or more non-recommendation-accepting-user playlist content item recommendations, wherein generation takes into account the acceptances.

9. A method, comprising:
receiving, at a processing device, a playlist content item recommendation generation request;
receiving, at the processing device, a playlist description;
generating, at the processing device, one or more playlist content item recommendations for a playlist using the playlist description; and
providing, by the processing device, one or more of the generated playlist content item recommendations.

10. The method of claim 9, further comprising:
receiving, at the processing device, one or more acceptances of one or more of the playlist content item recommendations; and
generating, at the processing device, one or more additional playlist content item recommendations, wherein generation takes into account the acceptances.

11. The method of claim 9, further comprising:
receiving, at the processing device, indication of one or more playlist content item additions which were not subject of said recommendations; and
generating, at the processing device, one or more additional playlist content item recommendations, wherein generation takes into account the playlist content item additions.

12. The method of claim 9, further comprising:
receiving, at the processing device, indication of one or more playlist content item deletions, wherein the deleted content items correspond to content items which were subject of said recommendations; and
generating, at the processing device, one or more additional playlist content item recommendations, wherein generation takes into account the deletions.

13. The method of claim 9, further comprising:
receiving, at the processing device, indication of one or more playlist content item deletions, wherein the deleted content items correspond to content items which were not subject of said recommendations; and
generating, at the processing device, one or more additional playlist content item recommendations, wherein generation takes into account the deletions.

14. The method of claim 9, further comprising:
receiving, at the processing device, an updated playlist description; and
generating, at the processing device, one or more additional playlist content item recommendations, wherein generation takes into account the updated description.

15. The method of claim 9, wherein generation further takes into account one or more of:
title metadata of one or more content items;
description metadata of one or more content items;
genre metadata of one or more content items;
keyword metadata of one or more content items;
user comment metadata regarding one or more content items;
transcript metadata of one or more content items;
title metadata of one or more playlists containing one or more content items; or
description metadata of one or more playlists containing one or more content items.

16. The method of claim 9, further comprising:
receiving, at the processing device, one or more acceptances of one or more of the playlist content item recommendations; and
generating, at the processing device, one or more non-recommendation-accepting-user playlist content item recommendations, wherein generation takes into account the acceptances.

17. A method, comprising:
receiving, via a user interface, playlist information;
sending a request for one or more playlist content item recommendations, wherein the request comprises the playlist information;
receiving the one or more playlist content item recommendations;
identifying, via the user interface, one or more acceptances of the playlist content item recommendations; and
adding to a playlist, in accordance with the acceptances, one or more content items.

18. The method of claim 17, wherein the playlist information comprises one or more of a playlist title, a playlist description, or one or more playlist entries.

19. The method of claim 17, further comprising:
displaying, via the user interface, information regarding one or more of the recommended content items;
presenting via the user interface, for each of the one or more content items for which information is displayed, an addition user interface element; and
receiving, via the user interface, activation of one or more of the addition user interface elements.

20. The method of claim 19, further comprising:
receiving one or more additional playlist content item recommendations;
displaying, via the user interface, information regarding one or more of the additional recommended content items; and
redisplaying, via the user interface, information regarding recommended content items for which there was no addition element activation.

21. An apparatus, comprising:
a memory; and
a processing device communicably coupled to the memory, the processing device to execute instructions to:
receive a playlist content item recommendation generation request;
receive a playlist title;
generate one or more playlist content item recommendations for a playlist using the playlist title; and
provide one or more of the generated playlist content item recommendations.

22. The apparatus of claim 21, wherein the processing device further executes instructions to:
receive one or more acceptances of one or more of the playlist content item recommendations; and
generate one or more additional playlist content item recommendations, wherein generation takes into account the acceptances.

23. The apparatus of claim 21, wherein the processing device further executes instructions to:
receive indication of one or more playlist content item deletions, wherein the deleted content items correspond to content items which were subject of said recommendations; and
generate one or more additional playlist content item recommendations, wherein generation takes into account the deletions.

24. The apparatus of claim 21, wherein the processing device further executes instructions to:
receive an updated playlist title; and
generate one or more additional playlist content item recommendations, wherein generation takes into account the updated title.

25. The apparatus of claim 21, wherein the processing device further executes instructions to:
receive one or more acceptances of one or more of the playlist content item recommendations; and
generate one or more non-recommendation-accepting-user playlist content item recommendations, wherein generation takes into account the acceptances.

26. A non-transitory machine-readable storage medium storing instructions which, when executed, cause a processing device to perform operations comprising:
receiving, at the processing device, a playlist content item recommendation generation request;
receiving, at the processing device, a playlist title;
generating, at the processing device, one or more playlist content item recommendations for a playlist using the playlist title; and
providing, by the processing device, one or more of the generated playlist content item recommendations.

27. The non-transitory machine-readable storage medium of claim 26, wherein the processing device performs operations further comprising:
receiving, at the processing device, one or more acceptances of one or more of the playlist content item recommendations; and
generating, at the processing device, one or more additional playlist content item recommendations, wherein generation takes into account the acceptances.

28. The non-transitory machine-readable storage medium of claim 26, wherein the processing device performs operations further comprising:
receiving, at the processing device, indication of one or more playlist content item deletions, wherein the deleted content items correspond to content items which were subject of said recommendations; and
generating, at the processing device, one or more additional playlist content item recommendations, wherein generation takes into account the deletions.

29. The non-transitory machine-readable storage medium of claim 26, wherein the processing device performs operations further comprising:
receiving, at the processing device, an updated playlist title; and
generating, at the processing device, one or more additional playlist content item recommendations, wherein generation takes into account the updated title.
